(19) United States
(12) Patent Application Publication
(10) Pub. No.: US 2026/0302934 A1
(43) Pub. Date: Oct. 1, 2026

(54) AC-TO-DC VOLTAGE CONVERTER

(71) Applicant: Vladimir Anatolyevich POLIKARPOV, Moscow (RU)

(72) Inventors: Vladimir Anatolyevich POLIKARPOV, Moscow (RU); Anatoliy Grigoryevich POLIKARPOV, Moscow (RU)

(21) Appl. No.: 19/153,541

(22) PCT Filed: Feb. 2, 2024
(86) PCT No.: PCT/RU2024/000028

§ 371 Date: Aug. 4, 2025

(30) Foreign Application Priority Data
Feb. 2, 2023 (RU) 2023102269

(51) Int. Cl. H02M 1/42; H02M 7/25

(52) U.S. Cl. CPC H02M 1/4258; H02M 7/25

(57) ABSTRACT

The invention relates to electrical engineering, and more particularly to AC-to-DC voltage converters, and can be used in secondary power supply systems for power factor correction, conversion, and DC output voltage regulation.

It is an object of the invention to form a constant output voltage from an alternating input voltage, implement galvanic isolation between input and output circuits, combine the control circuits of the counter-series connected controlled switches, improve the performance of the power factor corrector, simplify the control circuit.

The claimed device contains a regulating switch (3), the control electrodes of which are combined into a common point connected to a control circuit (10), and a power transformer (2), a primary winding (1) of which is connected via the regulating switch (3) to a source of alternating voltage, and a secondary winding (4) of which is connected via rectifying diodes (5, 8) to series-connected filter capacitors (6, 7), to which a load (9) is connected in parallel.

In the proposed AC-to-DC converter, the beginning of the primary winding 1 of the transformer 2 is connected to the first pole of the input AC voltage source, and the end of the primary winding 1 via the controllable counter-series connected switch 3 is connected to the second pole of the input AC voltage source. The anode of the rectifier diode 5 is connected to the beginning of the secondary winding 4 of the transformer 2, the cathode of which is connected to one of the leads of the capacitor 6. Second lead of capacitor 6 is connected to end of winding 4. The end of winding 4 is connected to one of leads of capacitor 7 whose second lead is connected to anode of rectifier diode 8 whose cathode is connected to beginning of winding 4. The load 9 is connected in parallel to the series-connected capacitors 6 and 7. The control electrodes of the counter-series connected switch 3 are combined into a common point and connected to the pulse-width controller 10, the second output of which is connected to the common connection point of switches of the counter-series connected switch 3.

The invention relates to electrical engineering, and more particularly to AC-to-DC voltage converters, and can be used in secondary power supply systems for power factor correction, conversion, and DC output voltage regulation.

AC voltage regulators are known to directly connect the load via rectifier diodes and a smoothing capacitive filter [US U.S. Pat. No. 6,282,109 b 1 28.08.2001].

The disadvantage of known AC voltage regulators is the absence of galvanic isolation between the source of input sinusoidal voltage and constant output voltage, as well as separate control of switches connected to the AC voltage circuit, which complicates the control circuit.

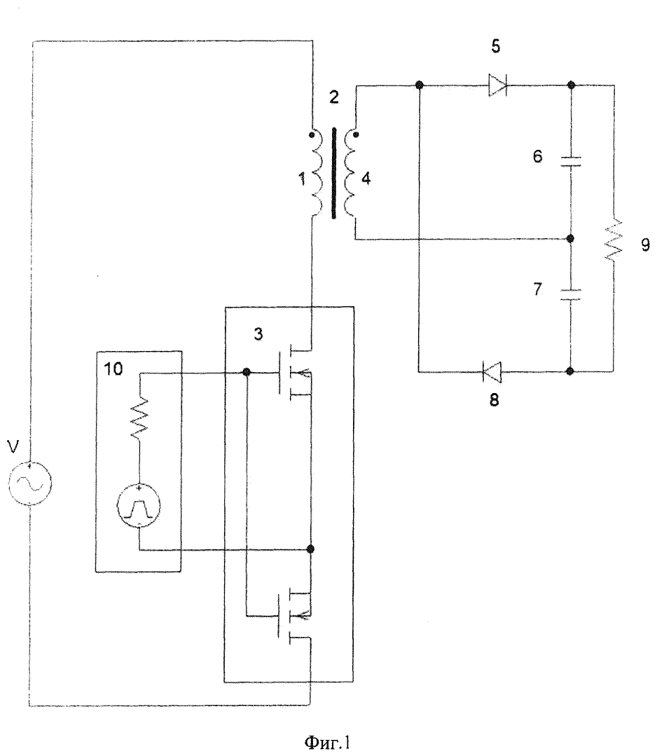

The most close in technical essence to the proposed device a regulator of alternating sinusoidal voltage into a constant output voltage, comprising a choke winding connected via counter-series connected controlled switches to terminals of a source of alternating sinusoidal voltage, rectifier diodes connected by anodes to output terminals of counter-series connected controlled switches, the cathodes of which are connected to the capacitive filter and load [FIG. 1 U.S. Pat. No. 6,282,109 b1 28.08.2001].

The disadvantages of this regulator are that there is no galvanic isolation of the input and output circuits of the regulator, as well as separate switch control, which complicates the switch control device.

It is an object of the invention to form a constant output voltage from an alternating input voltage, implement galvanic isolation between input and output circuits, combine the control circuits of the counter-series connected controlled switches, improve the performance of the power factor corrector, simplify the control circuit.

This object is achieved by the fact that in the AC voltage regulator, a secondary winding is introduced to the primary winding of the choke connected in series with the AC voltage sources and the counter-series connected controlled switches, which is connected through the rectifier diodes to the capacitive filter and the load, and the control electrodes of the counter-series connected controlled switches are combined and the common electrode are connected to the control device.

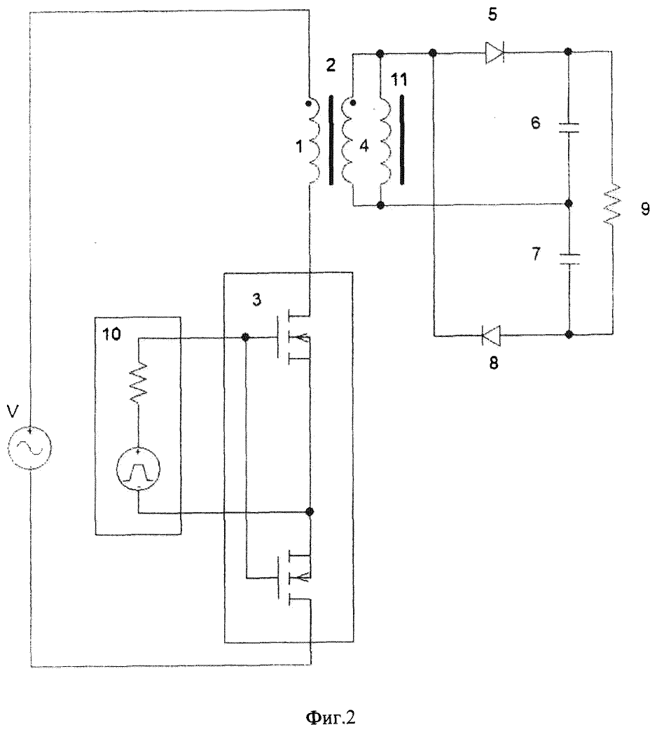

FIGS. 1 and 2 are schematic electrical diagrams of embodiments of the proposed AC-to-DC voltage converter. FIG. 1 is a schematic diagram of an AC-to-DC voltage converter; FIG. 2 is a schematic diagram of an AC-to-DC voltage converter with additional linear inductance.

In it (FIG. 1), the beginning of the primary winding 1 of the transformer 2 is connected to the first pole of the input AC voltage source, and the end of the primary winding 1 via the controllable counter-series connected switch 3 is connected to the second pole of the input AC voltage source. The anode of the rectifier diode 5 is connected to the beginning of the secondary winding 4 of the transformer 2, the cathode of which is connected to one of the leads of the capacitor 6. Second lead of capacitor 6 is connected to end of winding 4. The end of winding 4 is connected to one of leads of capacitor 7 whose second lead is connected to anode of rectifier diode 8 whose cathode is connected to beginning of winding 4. The load 9 is connected in parallel to the series-connected capacitors 6 and 7. The control electrodes of the counter-series connected switch 3 are combined into a common point and connected to the pulse-width controller 10, the second output of which is connected to the common connection point of switches of the counter-series connected switch 3.

In FIG. 2, a linear inductance 11 is connected in parallel to the secondary winding 4 of the transformer 2.

The operation of the proposed AC-to-DC voltage converter is based on the preposition of the ideality of the switch elements, the steady-state operation mode and the continuity of the change in the magnetic flux in the core of the transformer 2.

Let us assume that at the moment of considering the operation of the AC-to-DC converter, a positive half-wave of sinusoidal voltage is supplied from the AC voltage source.

In this case, in the closed state step DT of the switch 3, the MOSFET of the switch 3 operates in a normal switch mode (in the considered case the upper), and the second (lower) in the synchronous rectifier mode. In this time interval, energy is transferred to the load via a directly biased rectifier diode 5 and a secondary winding 4. In this case, at the stage of the closed state of DT switch 3, the field-effect transistor (MOSFET) of the switch 3 operates in the normal switch mode (in this case, the upper one), and the second (lower one) in the synchronous rectifier mode. During this time interval, energy is transferred to the load through the forward-biased rectifier diode 5 and the secondary winding 4.

The amount of current through the rectifier diode 5 is determined by the balance of the charges of the capacitor 6 at time intervals DT and (1-D) T, i.e. on the time intervals of the on and off state of the switch 3. The balance of charges may be affected by the introduction of an additional linear inductance 11 connected in parallel to the secondary winding 4 of the transformer 2 (FIG. 2). This effect is reflected in the form of the current flowing through the switch 3 and, as a consequence, affects the power factor correction.

After switching off the switch 3 in the time interval (1-D) T, the voltage across the windings of the transformer 2 changes the sign. As a consequence, the rectifier diode 5 closes and the diode 8 opens, allowing the energy accumulated in the transformer 2 in the time interval DT to remove to the capacitor 7 via the rectifier diode 8 and the secondary winding 4 of the transformer 2.

When the polarity of the input voltage source changes, all the processes described above are repeated with only the difference that the lower field-effect transistor (MOSFET) of the switch 3 is operating in the normal switch mode, and the upper in the synchronous rectifier mode. With the changed polarity of the input voltage source, direct energy transfer to the output circuit of the capacitor 7 goes through the rectifier diode 8 and the secondary winding 4 of the transformer 2 during the time interval DT, and the energy removed from the transformer during the time interval (1-D)T goes through the diode 5 to the winding 4 to the capacitor 6.

The sum of the voltages on the capacitors 6 and 7 is the output voltage at the load 9.

Thus, the proposed AC-to-DC voltage converter allows, in comparison with the known device, allows to implement the electrical isolation of the output direct voltage from the alternating input voltage, as well as simplify the control of the counter-series connected switch 3 by combining the control electrodes to a common point.

### Formula of the Invention

1. The AC-to-DC voltage converter, comprising a choke, having a primary winding connected through a controlled counter-series connected switch to input terminals of the AC voltage source, rectifier diodes connected to output leads of the filter capacitor, characterized in that in order to form a constant output voltage from the alternating input voltage, perform galvanic isolation between the input and output circuits, combine the control circuit of the counter-series connected switch, improve performance of the power factor corrector and simplify the control circuit, a secondary winding implementing a transformer is introduced into the choke, which is connected through a series-connected diode to the leads of the first capacitor, through the second series-connected diode, which removes the reactive energy of the transformer, in parallel to which the load is connected, and the control electrodes of the counter-series connected switch are combined into a common connection point, to which a controller is connected, the second output of which is connected to the common connection point of switches of the counter-series connected switch.
2. The AC-to-DC voltage converter according to paragraph 1, characterized in that a linear inductance is connected in parallel to one of the transformer windings, for example the secondary winding.

1. The AC-to-DC voltage converter, comprising a choke, having a primary winding connected through a controlled counter-series connected switch to input terminals of the AC voltage source, rectifier diodes connected to output leads of the filter capacitor, characterized in that in order to form a constant output voltage from the alternating input voltage, perform galvanic isolation between the input and output circuits, combine the control circuit of the counter-series connected switch, improve performance of the power factor corrector and simplify the control circuit, a secondary winding implementing a transformer is introduced into the choke, which is connected through a series-connected diode to the leads of the first capacitor, through the second series-connected diode, which removes the reactive energy of the transformer, in parallel to which the load is connected, and the control electrodes of the counter-series connected switch are combined into a common connection point, to which a controller is connected, the second output of which is connected to the common connection point of switches of the counter-series connected switch.

2. The AC-to-DC voltage converter according to paragraph 1, characterized in that a linear inductance is connected in parallel to one of the transformer windings, for example the secondary winding.
